(19) United States
(12) Patent Application Publication
(10) Pub. No.: US 2005/0002314 A1
(43) Pub. Date: Jan. 6, 2005

(54) Optical pickup device

(76) Inventors: Yuichi Hasegawa, Yokosuka-shi (JP); Makoto Itonaga, Yokohama-shi (JP)

Correspondence Address: NATH & ASSOCIATES, PLLC, Sixth Floor, 1030 15th Street, N.W., Washington, DC, 20005-1503, US

(21) Appl. No.: 10/880,439

(22) Filed: Jun. 30, 2004

(30) Foreign Application Priority Data
Jul. 4, 2003 (JP) P2003-192476

(51) Int. Cl. G11B 11/00; G11B 7/00

(52) U.S. Cl. 369/112.05; 369/112.28

(57) ABSTRACT

After diffracting laser light by a diffraction grating to separate the light into three beams of a 0-order light and ±1st order lights, the three beams are enlarged by a beam shaping/PBS synthesizing prism to shape an elliptic light intensity distribution thereof into a substantially circular light intensity distribution. In this case, it is assumed that a direction for enlarging diameters in shaping the three beams into the substantially circular light intensity distribution by the beam shaping/PBS synthesizing prism is an x-axis and an axis crossing a plane including the x-axis and an optical axis at right angles is a y-axis. At this time, the diffraction grating is formed along an xy-plane including the x-axis and the y-axis, and an angle formed by the xy-plane and the optical axis is set to a predetermined angle other than a right angle so that the grating formed along the xy-plane is substantially parallel to the x-axis.

### BACKGROUND OF THE INVENTION

1. Technical Field of the Invention

The present invention relates to an optical pickup device capable of effectively producing three beams to irradiate a signal surface of an extra-high density optical recording medium from an objective lens especially for the extra-high density optical recording medium formed by narrowing a track.

2. Description of the Related Art

In general, disc-shaped and card-shaped optical recording mediums such as an optical disc and an optical card have been frequently used, because desired tracks are accessible at a high rate in recording information signals such as video information, sound information, and computer data on spirally or concentrically formed tracks on a transparent substrate with high density and in reproducing a recorded track.

As an optical disc constituting this type of optical recording medium, for example, a compact disc (CD), a digital versatile disc (DVD), or the like has been already on the market. In recent years, in order to further increase density of the optical disc, an extra-high density optical disc (Blu Ray Disc) has been well developed, which is capable of recording or reproducing the information signals at an extra-high density while narrowing tracks as compared with the above-described CD and DVD.

The above-described extra-high density optical disc has been developed in such a manner that a laser beam obtained by focusing a laser beam having a wavelength of 450 nm or less with an objective lens having a numerical aperture (NA) of 0.75 or more is applied and that the information signals can be recorded on or reproduced from the signal surface disposed in a position distant from a laser beam incidence surface by about 0.1 mm with an extra-high density. In this case, a recording capacity of one surface of the extra-high density optical disc is around 25 gigabytes (GB), when a disc substrate has a diameter of 12 cm.

Additionally, there are various types of structural configurations of an optical pickup device for recording or reproducing the extra-high density optical disc. As an example, there is a device comprising: a laser light source in which a reference wavelength of laser light is about 400 nm; sphere aberration correction means for correcting sphere aberration generated by an optical condenser system disposed on an optical axis between the laser light source and the signal surface of the extra-high density optical disc; and an aspheric single objective lens whose numerical aperture is larger than 0.85 and which is lightweight (see Japanese Patent Application Laid-Open No. 2003-5032 (page 9, FIG. 2), for example).

Moreover, there is an optical pickup device for producing three beams to irradiate the optical recording medium from the objective lens during the recording or reproducing of the optical recording medium, comprising: at least a semiconductor laser; a diffraction grating which diffracts laser light emitted from the semiconductor laser to produce three beams including 0-order light and ±1st order lights; a beam shaping prism which enlarges diameters of three beams to shape a substantially circular light intensity distribution from an elliptic light intensity distribution; an objective lens for irradiating the optical recording medium with the three shaped beams; and a photodetector which detects reflected light from the optical recording medium (see Japanese Patent Application Laid-Open No. 2001-344805 (page 6, FIG.1), for example).

FIG. 1 is a constitution diagram showing an optical pickup device of Prior Art 1.

First, an optical pickup device 100 of Prior Art 1 shown in FIG. 1 is described in the Japanese Patent Application Laid-Open No. 2003-5032, and will be briefly described herein with reference to the publication.

As shown in FIG. 1, in the optical pickup device 100 of Prior Art 1, laser light L having a reference wavelength of about 400 nm, emitted from a laser light source 101 for an extra-high density information recording medium, passes through a coupling lens 102, beam shaping prism pair 103, polarizing beam splitter 104, beam expander 105, ¼ wave plate 106, and diaphragm 107 in that order. A laser beam La obtained by focusing the light by an aspheric single objective lens 108 whose numerical aperture is larger than 0.85 and which is lightweight is applied onto a signal surface 109a via a protective layer 109 of the information recording medium. Thereafter, in reverse to the above-described order, return light Lb reflected by the signal surface 109a passes through the diaphragm 107, ¼ wave plate 106, and beam expander 105 in that order. The light is reflected by the polarizing beam splitter 104, and passes through a cylindrical lens 111 and a focusing lens 112 to reach a photodetector 113, and thus signal surface information is detected.

Here, the beam expander 105 which is sphere aberration correction means comprises a negative lens 105A, single-axis actuator 105B, and positive lens 105C, and the negative lens 105A is capable of shifting along an optical axis direction with respect to the positive lens 105C by the single-axis actuator 105B. The aspheric single objective lens 108 is driven in a focusing direction and a tracking direction by a biaxial actuator 110.

In the optical pickup device 100 of Prior Art 1 constituted as described above, the beam expander 105 is operated in accordance with fluctuation of the laser light L emitted from the laser light source 101 with respect to the reference wavelength, environmental change, thickness error of the protective layer 109 of the information recording medium, and manufacturing error of the aspheric single objective lens 108. Accordingly, the sphere aberration generated in the optical condenser system disposed on the optical axis between the laser light source 101 and the signal surface 109a of the information recording medium can be corrected.

On the other hand, in the optical pickup device for the optical recording medium (optical disc), the laser light emitted from the semiconductor laser is diffracted to produce three beams comprising the 0-order light and ±1st order lights using the diffraction grating in a tracking servo system, and the signal surface of the optical disc is irradiated with the three beams by the objective lens. In this case, there is a method of producing a main spot for reading a main signal on the signal surface of the optical recording medium and a pair of sub-spots for obtaining an error signal for the tracking in positions distant from the main spot by a predetermined distance, and this method is performed by the optical pickup device of Prior Art 2.

FIG. 2 is a constitution diagram showing the optical pickup device of Prior Art 2. FIG. 3 is an explanatory view showing that a tracking error signal is detected, when an optical storage medium is irradiated with three beams.

An optical pickup device 200 of Prior Art 2 shown in FIG. 2 is described in the above-described Japanese Patent Application Laid-Open No. 2001-344805, and will be described briefly with reference to the publication.

As shown in FIG. 2, in the optical pickup device 200 of Prior Art 2, the laser light emitted from a semiconductor laser 201 is converted to parallel beams by a collimator lens 202, and the light is subsequently diffracted by a diffraction grating 203 and separated into three beams comprising the 0-order light and ±1st order lights (hereinafter referred to as three beams). Thereafter, the three beams are incident upon a beam shaping prism 204.

Here, the beam shaping prism 204 is also referred to as an anamorphic prism, and is formed in a triangular prism shape to produce an image having different magnifications in lateral and longitudinal directions. In the beam shaping prism 204, beams having an elliptic light intensity distribution whose horizontal direction is short because of an emission structure of the laser light from the semiconductor laser 201 is incident upon an incidence surface 204a inclined in a horizontal direction in accordance with a predetermined prism vertical angle, and refracted by the incidence surface 204a to expand a beam diameter of the horizontal direction in accordance with a shaping magnification. In this case, since a width of the beam in a vertical direction with respect to a sheet surface is unchanged in the refraction on the incidence surface 204a inclined in the horizontal direction in accordance with the predetermined prism vertical angle, the beams of the elliptic light intensity distribution are shaped into those of a substantially circular light intensity distribution.

Furthermore, the beams of the substantially circular light intensity distribution shaped by the beam shaping prism 204 pass through a polarizing beam splitter (PBS) 205 formed in a cubical shape using optical glass and a ¼ wave plate 206 in that order, and are converged on the signal surface of an optical storage medium 208 by an objective lens 207.

In this case, as shown in (a) and (b) of FIG. 3, a main beam by the 0-order light among three beams diffracted by the diffraction grating 203 is converged as a main spot M on a concave groove G spirally or concentrically formed on the signal surface of the optical storage medium 208. On the other hand, a pair of sub-beams by the ±1st order lights among three beams are converged as a pair of sub-spots S1, S2 on convex lands L, L formed on the both sides of the concave groove G, and accordingly the pair of sub-spots S1, S2 are disposed deviating from the main spot M by ½ of a track pitch Tp in a radial direction of the optical storage medium 208.

In this case, the groove G on which the main spot M is converged constitutes a track to record or reproduce information signals, but the main spot M may also be converged on the land L to constitute the track which records or reproduces the information signals.

Turning back to FIG. 2, thereafter, in reverse to the above-described order, return light reflected by the signal surface of the optical storage medium 208 passes through the objective lens 207 and ¼ wave plate 206 in that order, and is reflected by a polarized light separating surface 205b of the polarizing beam splitter 205 to turn its direction by approximately 90°. Thereafter, the light passes through a detection lens 209 and cylindrical lens 210 in that order, and reaches a photodetector 211. Moreover, the photodetector 211 detects a main signal, focus error signal, and tracking error signal from the signal surface of the optical storage medium 208. It is to be noted that in the following description, description of the detection of the main signal and focus error signal is omitted.

In this case, when the objective lens 207 largely moves by tracking control (when the optical axis deviates), or relative tilt occurs between the optical storage medium 208 and the objective lens 207, the tracking error signal includes an offset. A differential push pull (DPP) method is applied as a method of detecting the tracking error signal while canceling the offset. In the Japanese Patent Application Laid-Open No. 2001-344805, an example is described in which three bisection light receiving elements (not shown) are disposed with respect to the main spot M and the pair of sub-spots S1, S2 in the photodetector 211. A tracking error signal detection circuit 50 capable of enhancing detection precision of the DPP method and detecting the main signal, focus error signal, and tracking error signal with a quadruple light receiving element is used in a constitution shown in (c) of FIG. 3.

That is, as shown in (c) of FIG. 3, in the tracking error detection circuit 50 to which the DPP method is applied, a quadruple light receiving element 51 for detecting the main spot M and a pair of bisection light receiving elements 52, 53 for detecting the pair of sub-spots S1, S2 are disposed on a semiconductor substrate (not shown) in the photodetector.

In this case, the quadruple light receiving element 51 includes light receiving regions a to d. On the other hand, the light receiving element 52 includes light receiving regions e, f, the light receiving element 53 includes light receiving regions g, h, and dividing lines of the light receiving regions (e, f), (g, h) of the light receiving elements 52, 53 have a direction crossing a diametric direction (radial direction) of the optical storage medium 208 at right angles.

Here, the tracking error detection circuit 50 will be described. The quadruple light receiving element 51 receives the main spot M with four divided light receiving regions a to d, adds outputs of the light receiving regions a, c with an adder 54, and adds outputs of the light receiving regions b, d with an adder 55. Thereafter, a difference between the outputs of the adders 54, 55 is calculated with a subtracter 56, and a push-pull signal TE1 having information of {(a+c)-(b+d)} is output from the subtracter 56.

Moreover, the light receiving element 52 receives the sub-spot S1 by the +1st order light with two divided light receiving regions e, f, calculates a difference between the outputs of the light receiving regions e, f with a subtracter 57, and outputs a push-pull signal TE2 having information of (e-f) from the subtracter 57.

Furthermore, the light receiving element 53 receives the sub-spot S2 by the −1st order light with two divided light receiving regions g, h, calculates a difference between the outputs of the light receiving regions g, h with a subtracter 58, and further multiplies a push-pull signal TE3 by a gain constant G2 with a gain amplifier 59 to output a gain output G2 TE3 from the gain amplifier 59.

Thereafter, the push-pull signal TE2 from the subtracter 57 and the gain output G2·TE3 from the gain amplifier 59 are added by an adder 60 to obtain an added output (TE2+G2·TE3), and further the added output (TE2+G2·TE3) is multiplied by a gain constant G1 with a gain amplifier 61 to output a gain output G1·(TE2+G2·TE3) from the gain amplifier 61.

Furthermore, a difference between the push-pull signal TE1 from the subtracter 56 and the gain output G1·(TE2+G2·TE3) from the gain amplifier 61 is calculated by a subtracter 62, and accordingly a tracking signal TE=TE1−G1·(TE2+G2·TE3) is obtained from the subtracter 62.

Additionally, according to the tracking error detection circuit 50 constituted as described above, the push-pull signals of the sub-spots S1, S2 appear with a phase deviating from that of the push-pull signal of the main spot M just by 180° in a case where the spot moves along the track (groove G, land L) of the optical storage medium 208 in a radial direction of the optical storage medium 208. On the other hand, a component generated at a time when relative positions of the spots on the light receiving elements 51 to 53 shift due to lens shift and so on and thus a light intensity balance collapses changes with the same phase in the main spot M and sub-spots S1, S2. Therefore, when the main spot M and the sub-spots S1, S2 are differentiated, it is possible to cancel the offset generated by the lens shift.

Additionally, with respect to the extra-high density optical recording medium (extra-high density optical disc) formed by narrowing the track, technical thought of the sphere aberration correction means 105 in the optical pickup device 100 of Prior Art 1 shown in FIG. 1 is combined with that of the diffraction grating 203 for producing three beams and the beam shaping prism 204 in the optical pickup device 200 of Prior Art 2 shown in FIG. 2 to develop a new optical pickup device for the extra-high density optical recording medium. In this case, it has been found that an optical problem described below occurs with respect to the diffraction grating 203 for producing three beams and the beam shaping prism 204 in the optical pickup device 200 of Prior Art 2. This problem will be described with reference to FIGS. 4 and 5.

FIG. 4 is a perspective view schematically showing a structural configuration in which a problem occurs with respect to the diffraction grating for producing three beams and the beam shaping prism in the optical pickup device of Prior Art 2. FIG. 5 is a plan view showing that the optical recording medium is irradiated with three beams emitted from the beam shaping prism shown in FIG. 4 via the objective lens.

As shown in FIG. 4, when three beams obtained through the diffraction grating 203 are enlarged by the beam shaping prism 204, and shaped to the substantially circular light intensity distribution from the elliptic light intensity distribution, the horizontal direction for enlarging the three beams by the beam shaping prism 204 is set to an x-axis. Moreover, an axis crossing a plane including the x-axis and the optical axis of the laser light at right angles is set to a y-axis. Then, the diffraction grating 203 can be displayed along a rectangular xy-plane including the x-axis and y-axis, the xy-plane constitutes an incidence surface 203a on the side of the collimator lens 202 (FIG. 2), and the reverse side thereof constitutes an emission surface 203b.

Furthermore, a binary phase grating (not shown) is formed in a concave/convex form at a predetermined pitch in parallel with the x-axis on the emission surface 203b of the diffraction grating 203 described above. Moreover, normal lines of the incidence surface 203a and emission surface 203b match the optical axis of the laser light. Therefore, an angle θ formed by the xy-plane and the optical axis of the laser light is θ=90°. That is, the xy-plane of the diffraction grating 203 is disposed crossing the optical axis of the laser light at right angles.

When the laser light from the semiconductor laser 201 is incident upon the incidence surface 203a of the diffraction grating 203, and emitted toward the incidence surface 204a of the beam shaping prism 204 from the emission surface 203b in this state, the laser light is diffracted by the binary phase grating (not shown) formed on the emission surface 203b and separated in three beams from a point O on the optical axis, and the three beams are emitted on the side of the beam shaping prism 204.

In this case, the 0-order light constituting the main beam among three beams travels straight along the optical axis of the laser light to reach a point m on the incidence surface 204a of the beam shaping prism 204. On the other hand, the ±1st order lights constituting the sub-beams are diffracted vertically symmetrically centering on the 0-order light by an angle α to reach points s1, s2 on the incidence surface 204a of the beam shaping prism 204, and the points s1 and s2 are linearly arranged in a vertical direction with the point m between (y-axis direction) on the incidence surface 204a of the beam shaping prism 204.

Here, the 0-order light having no angle with respect to the optical axis of the laser light and the ±1st order lights diffracted by the binary phase grating (not shown) of the diffraction grating 203 to have a certain angle α with respect to the optical axis of the laser light among three beams diffracted by the diffraction grating 203 are incident upon the incidence surface 204a inclined in the horizontal direction in accordance with a predetermined prism vertical angle in the beam shaping prism 204. At this time, since an incident angle of each beam with respect to the incidence surface 204a of the beam shaping prism 204 differs, the ±1st order lights have a slight difference from the 0-order light, in a refraction direction by the beam shaping prism 204.

That is, since the 0-order light has only an angle component βx of an x-direction with respect to the incidence surface 204a of the beam shaping prism 204, the refraction direction of a ray incident upon the incidence surface 204a is only the x-direction, and an angle component of a y-direction is βy=90°. On the other hand, the ±1st order lights are also incident upon the incidence surface 204a of the beam shaping prism 204 with an angle also in the y-direction.

Therefore, the incident angle of each of the ±1st order lights with respect to the incidence surface 204a of the beam shaping prism 204 is decomposed into a y-direction component and an x-direction component. When the incident angle of the x-direction with respect to the incidence surface 204a increases, the component of the y-direction decreases, and the component of the x-direction increases. Accordingly, in respective beams emitted from an emission surface 204b of the beam shaping prism 204, the ±1st order lights are emitted also in the x-direction with an angle with respect to the 0-order light, that is, the ±1st order lights are emitted in the y-direction which is a diffraction direction by the diffraction grating 203 with symmetric angles with respect to the 0-order light, and emitted in the x-direction with the same angles.

Thereafter, when the shaped three beams are emitted from the emission surface 204b of the beam shaping prism 204, further incident upon an incidence surface 205a of the polarizing beam splitter 205, and emitted from an emission surface 205c through the polarized light separating surface 205b, the 0-order light is positioned in a point m′, and the ±1st order lights are positioned in vertical points s1′, s2′ with the point m′ between, deviating from the point m′ toward the left side (−x side) in the x-direction. Moreover, when the points s1′, m′, and s2′ are connected, the respective points are not on a line, and form a “>” shape. Needless to say, even when three beams are emitted from the emission surface 204b of the beam shaping prism 204, the same “>” shape as that formed when the beams are emitted from the emission surface 205c of the polarizing beam splitter 205 is obtained.

Moreover, as shown in FIG. 5, the three beams emitted from the emission surface 205c of the polarizing beam splitter 205 are applied onto the optical storage medium 208 via the objective lens 207 (FIG. 2), and the main spot M by the 0-order light and the sub-spots S1, S2 by the ±1st order lights are converged onto the optical storage medium 208 while the diffraction grating 203 is grating-adjusted. In this grating adjustment, the diffraction grating 203 is slightly rotated centering on the optical axis of the laser light. For example, the sub-spot S2 is adjusted to be disposed in a middle position (½ track position=Tp/2) of the land L on the left side of the groove G, and then the main spot M is disposed in the middle position of the groove G. However, the three beams emitted from the emission surface 205c of the polarizing beam splitter 205 have the above-described “>” shape, the other sub-spot S1 slightly deviates toward the left side from the middle position (½ track position=Tp/2) of the land L on the right side of the groove G, and a line connecting the sub-spot S1 and the main spot M and the sub-spot S2 substantially forms the “>” shape. Therefore, the sub-spots S1, S2 cannot be disposed in positions apart completely by ½ track in a state in which the main spot M is disposed in a center of the groove G.

That is, even if three beams of the 0-order light and ±1st order lights emitted from the diffraction grating 203 are linearly incident upon the incidence surface 204a of the beam shaping prism 204 along a vertical direction (y-axis direction), the ±1st order lights deviate from the 0-order light, for example, toward the left side (−x side) in the x-direction due to refraction on the incidence surface 204a when the three beams are emitted from the emission surface 204b.

More concretely, angles of the rays of the 0-order light and ±1st order lights at a time when three beams produced by the diffraction grating 203 in the structural configuration shown in Prior Art 2 are refracted by the beam shaping prism 204 are shown in Table 1 as follows.

TABLE 1

| Material | BK7 | |
|---|---|---|
| Shaping magnification | 1.5 | times |
| Prism vertical angle | 33.2 | deg |
| Incident angle | 56.895 | deg |
| Grating pitch | 43 | μm |
| Diffraction angle | 0.54365 | deg |
| 0-order light emission angle | | |
| X | 0 | deg |
| Y | 0 | deg |
| +1st order light emission angle | | |
| X | 0.001479 | deg |
| Y | −0.54365 | deg |
| −1st order light emission angle | | |
| X | 0.001479 | deg |
| Y | −0.54365 | deg |

In Table 1, 0-order light emission angle, +1st order light emission angle, and −1st order light emission angle emitted from the beam shaping prism 204 are shown in a case where borosilicate crown glass (BK7) is used as a material of the beam shaping prism 204, the shaping magnification is 1.5 times, the prism vertical angle is 33.2°, the incident angle of the 0-order light is 56.895°, the grating pitch of the diffraction grating 203 is 43 μm, and the ±1st order light diffraction angle of the diffraction grating 203 is 0.54365°.

That is, the 0-order light emitted from the diffraction grating 203 is incident upon the incidence surface 204a of the beam shaping prism 204 at an angle of 56.895° in the x-direction and 0° in the y-direction. Thereafter, the light is refracted only in the x-direction by the incidence surface 204a inclined in the horizontal direction in accordance with a prism vertical angle of 33.2°, and emitted from the emission surface 204b of the beam shaping prism 204 at 0° both in x and y-directions.

On the other hand, the ±1st order lights emitted from the diffraction grating 203 are incident at an angle of 56.895° which is equal to that of the 0-order light in the x-direction and at an angle of 0.54365° after the diffraction by the diffraction grating 203 in the y-direction. Thereafter, the light is emitted from the emission surface 204b of the beam shaping prism 204 at an angle of 0.001479° in the x-direction with respect to 0-order light and at an angle of −0.54365° (+1st order light), 0.54365° (−1st order light) in the y-direction.

Therefore, although there is not any difference in the angle of the x-direction between the 0-order light and the ±1st order lights before incidence upon the beam shaping prism 204, there is a difference in the angle of the x-direction after passage through the beam shaping prism 204.

Next, Table 2 shows a positional relation between the spots on the optical disc with the use of an objective lens having a focal distance of 2 mm.

TABLE 2

| | y-direction | x-direction |
|---|---|---|
| +1st order light | 0.013556 | 4.30E−05 |
| 0-order light | 0 | 0 |
| −1st order light | 0.013556 | 4.30E−05 |

unit: mm

In Table 2, by the use of the beam shaping prism (anamorphic prism), the positions of the ±1st order lights deviate in the x-direction by about 0.04 μm centering on the 0-order light by the diffraction grating. In a DVD, since this deviation is small, the track pitch is hardly influenced. However, in the extra-high density optical disc using blue purple laser light having a wavelength of 450 nm or less, the track pitch is about 0.32 μm. With the use of the DPP method, since the sub-spot is disposed apart from the main spot by ½ track, that is, 0.16 μm in a radial direction. Therefore, the deviation of about 0.04 μm is ¼ of the distance, and is not ignorable.

In actual, in a state in which the sub-spot deviates, a position where an amplitude of push-pull of the sub-spot is maximized deviates from a position where the amplitude of push-pull of the main spot is maximized. Therefore, the amplitude of the tracking error signal calculated from these positions decreases. Moreover, the offset is also generated. When the offset is not electrically corrected, there occurs a problem that off-track occurs and quality of the signal deteriorates.

### SUMMARY OF THE INVENTION

An object of the present invention is to provide an optical pickup device in which changes of positions of ±1st order lights caused by passage of three beams through a beam shaping prism from a diffraction grating are corrected to prevent any amplitude decrease and offset of a tracking error signal from occurring in an optical pickup using the diffraction grating and the beam shaping prism (anamorphic prism).

To achieve the object, there is provided an optical pickup device comprising: a semiconductor laser device which emits laser light having an elliptic light intensity distribution; a collimator lens which converts the laser light into parallel beams; a diffraction grating which diffracts the parallel beams to separate them into three beams of a 0-order light and ±1st order lights; a beam shaping prism which enlarges diameters of the three beams to shape the elliptic light intensity distribution into a substantially circular light intensity distribution; and an objective lens which irradiates an optical recording medium with the three beams shaped by the beam shaping prism, wherein assuming that an optical axis direction of a ray incident upon the beam shaping prism is a z-axis and two axes crossing the Z-axis at right angles are an x-axis and a y-axis, a direction of gratings of the diffraction grating is set to have a predetermined angle with respect to the X-axis so that spots on the optical recording medium based on the three beams emitted from the beam shaping prism align.

According to the present invention, especially after diffracting the laser light emitted from the semiconductor laser by the diffraction grating to separate the light into three beams of the 0-order light and the ±1st order lights, the three beams are enlarged by the beam shaping prism to shape the elliptic light intensity distribution thereof into the substantially circular light intensity distribution. In this case, it is assumed that an optical axis direction of a ray incident upon the beam shaping prism is a z-axis and two axes crossing the Z-axis at right angles are an x-axis and a y-axis. At this time, a direction of gratings of the diffraction grating is set to have a predetermined angle with respect to the X-axis so that spots on the optical recording medium based on the three beams emitted from the beam shaping prism align. Therefore, with respect to the 0-order light, the ±1st order lights can be incident upon an incidence surface deviating in a reverse direction beforehand in order to cancel a deviation in an x-direction caused by refraction through the incidence surface of the beam shaping prism. Therefore, when three beams emitted from the beam shaping prism are applied via an objective lens onto the signal surface of an extra-high density optical recording medium formed by narrowing a track, a main spot by the 0-order light is converged onto a groove (or a land) on the signal surface of an extra-high density optical disc, and a pair of sub-spots by the ±1st order lights are securely converged onto left/right lands (or grooves) adjacent to the groove (or the land). In other words, the pair of sub-spots can be disposed in the positions apart completely by a ½ track in a state in which the main spot is disposed in a center of the groove (or the land). Accordingly, since the tracking error signal can be securely detected from the signal surface of the extra-high density optical disc by the DPP method, and the offset or phase shift is not generated in the tracking error signal, the information signal can be recorded or reproduced with the extra-high density.

In a preferable embodiment of the present invention, the objective lens has a numerical aperture of 0.75 or more.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a constitution diagram showing an optical pickup device of Prior Art 1;

FIG. 2 is a constitution diagram showing the optical pickup device of Prior Art 2;

FIG. 3 is an explanatory view showing that a tracking error signal is detected, when an optical storage medium is irradiated with three beams;

FIG. 4 is a perspective view schematically showing a structural configuration in which a problem is caused with respect to a diffraction grating for producing three beams and a beam shaping prism in the optical pickup device of Prior Art 2;

FIG. 5 is a plan view showing that the optical recording medium is irradiated with three beams emitted from the beam shaping prism shown in FIG. 4 via an objective lens;

FIG. 6 is a constitution diagram showing a whole constitution of the optical pickup device according to the present invention;

FIGS. 7A and 7B are a plan view and a side view enlarging and showing the diffraction grating shown in FIG. 6;

FIG. 8 is a diagram enlarging and showing the vicinity of sphere aberration correction means and objective lens shown in FIG. 6;

FIG. 9 is a perspective view schematically showing a structural configuration in which a conventional problem with respect to the diffraction grating for producing three beams and a beam shaping/PBS synthesizing prism is solved in the optical pickup device according to the present invention; and

FIG. 10 is a plan view showing that the extra-high density optical disc is irradiated with three beams emitted from the beam shaping/PBS synthesizing prism shown in FIG. 9.

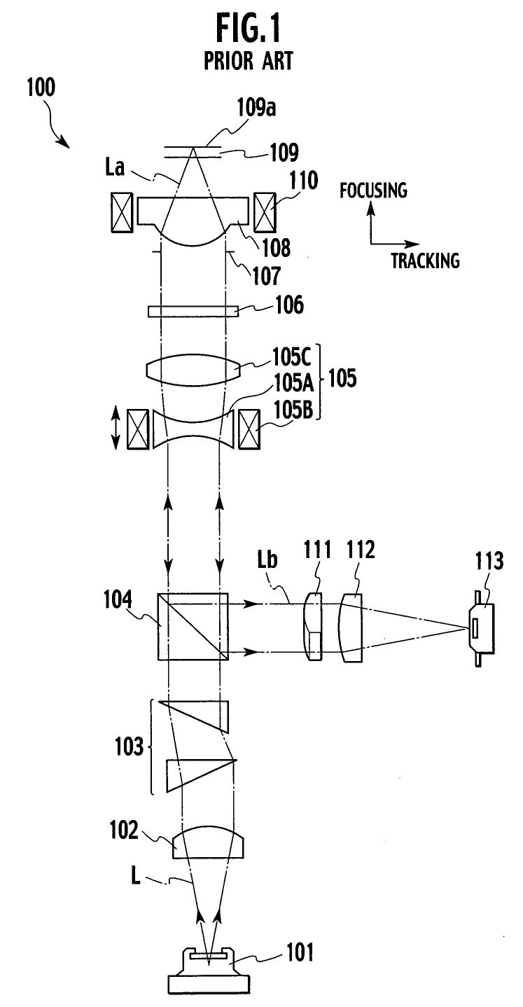

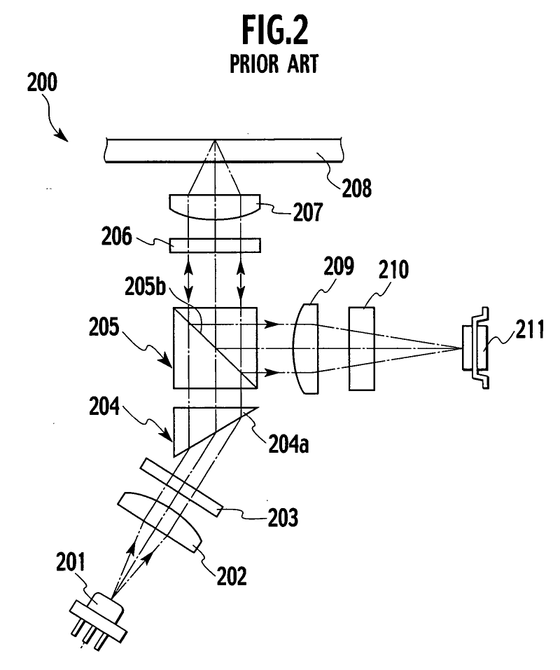

### DESCRIPTION OF THE PREFERRED EMBODIMENT

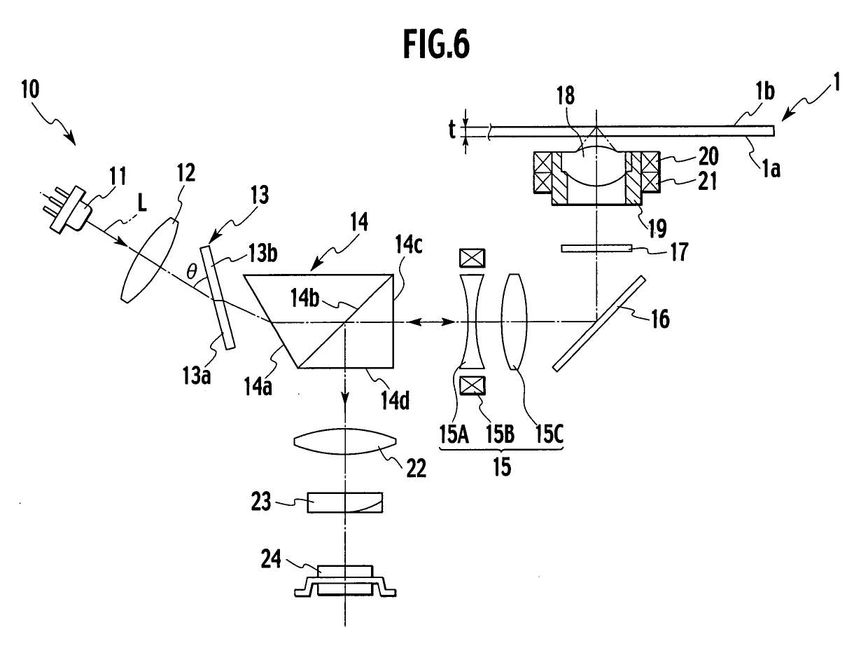

An embodiment of an optical pickup device according to the present invention will be described hereinafter in detail with reference to FIGS. 6 to 10.

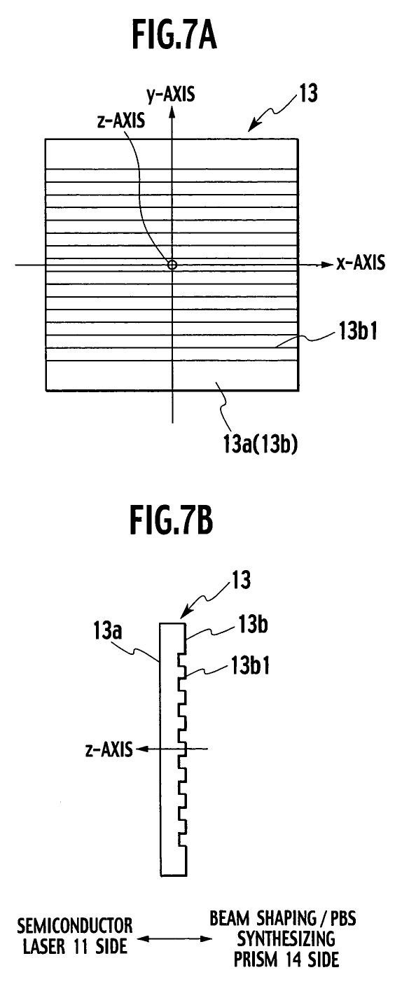

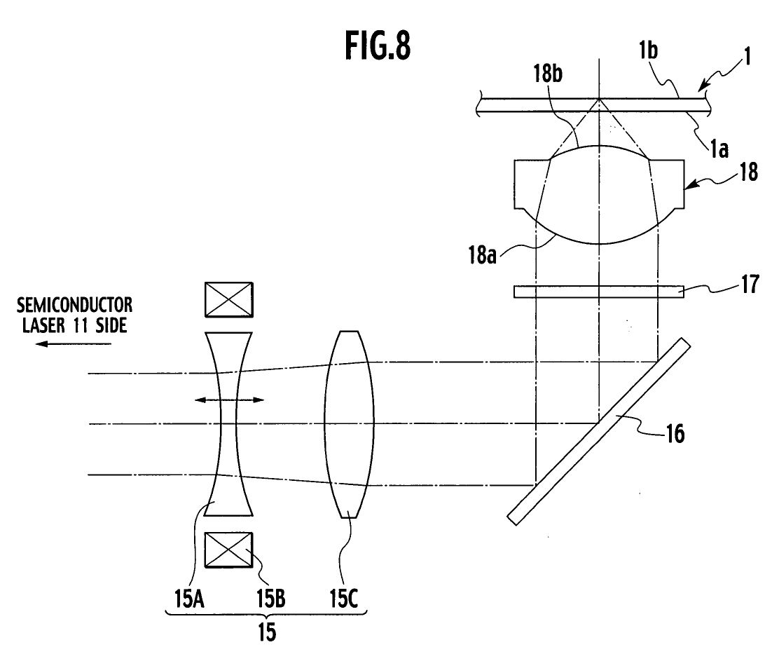

FIG. 6 is a constitution diagram showing a whole constitution of the optical pickup device according to the present invention. FIGS. 7A and 7B are a plan view and a side view enlarging and showing a diffraction grating shown in FIG. 6. FIG. 8 is a diagram enlarging and showing the vicinity of sphere aberration correction means and objective lens shown in FIG. 6.

An optical pickup device 10 according to the present invention shown in FIG. 6 records and/or reproduces an information signal with an extra-high density on and/or from a signal surface 1b of an extra-high density optical recording medium (hereinafter referred to as the extra-high density optical disc) 1 formed by narrowing a track. It is to be noted that in the embodiment, an example will be described hereinafter in which the optical pickup device 10 according to the present invention is applied to a disc-shaped extra-high density optical disc 1, but the present invention is not limited to this case, and the present invention may also be applied as the extra-high density optical recording medium to a rectangular optical card or the like.

First, as shown in FIG. 6, in the extra-high density optical disc (Blu Ray Disc) 1, a disc substrate thickness t between a laser beam incidence surface 1a and the signal surface 1b is set to be small, e.g. about 0.1 mm, and an about 1.1 mm thick reinforcing plate (not shown) is bonded to the disc and formed in a total thickness of about 1.2 mm.

In the optical pickup device 10, laser light L having a wavelength of 450 nm or less is emitted from a semiconductor laser 11 in accordance with the extra-high density optical disc 1, and a reference wavelength of the laser light L is set, for example, to 408 nm in the embodiment.

Moreover, the laser light L emitted from the semiconductor laser 11 is a linearly polarized divergent light. After this divergent light is converted to a parallel beam by a collimator lens 12, the parallel beam is incident upon a flat incidence surface 13a of a diffraction grating 13 rotated by a predetermined angle θ with respect to an optical axis of the laser light L and disposed, and diffracted by a binary phase grating 13b1 formed on an emission surface 13b as shown in FIGS. 7A and 7B. The beam is separated into three beams comprising 0-order diffracted light and ±1st order diffracted lights (hereinafter referred to as the three beams) in accordance with a pitch of the binary phase grating 13b1 and an angle of the inclination.

Different from Prior Art 2, the embodiment is characterized in that the diffraction grating 13 is rotated by the predetermined angle θ with respect to the optical axis of the laser light L and disposed as described above to solve conventional problems which occurs at the time of production of three beams. This respect will be described later in detail.

In the diffraction grating 13, as enlarged and shown in FIGS. 7A and 7B, the incidence surface 13a on the side of the semiconductor laser 11 and the collimator lens 12 is formed in a flat surface using a photo transmitting material, and the incidence surface 13a and the emission surface 13b which is the reverse side of the incidence surface 13a are indicated by an xy-plane including an x-axis and a y-axis crossing the x-axis at right angles. In this case, a binary phase grating 13b1 includes plural concaves/convexes having a predetermined pitch formed in parallel with the x-axis on the emission surface 13b. In this case, the direction of a z-axis is an optical axis direction of a ray incident upon a beam shaping/PBS synthesizing prism 14 and accordingly two axes crossing the Z-axis at right angles are the x-axis and the y-axis. It is to be noted that in the embodiment, the binary phase grating 13b1 is formed on the emission surface 13b of the diffraction grating 13, but a binary phase grating 13b1 may also be formed on the incidence surface 13a.

Turning back to FIG. 6, thereafter, the three beams obtained by the diffraction grating 13 are incident upon an incidence surface 14a inclined in the horizontal direction in accordance with a predetermined prism vertical angle in the beam shaping/PBS synthesizing prism 14 disposed on a side of the emission surface 13b of the diffraction grating 13. The beam shaping/PBS synthesizing prism 14 is formed by integrally combining a beam shaping prism (anamorphic prism) having a triangular prism shape as described in Prior Art 2 with a polarizing beam splitter (PBS) having a cubic shape. It is to be noted that in the embodiment, the beam shaping/PBS synthesizing prism 14 is used, but the beam shaping prism (anamorphic prism) having the triangular prism shape may also be used separately from the polarizing beam splitter (PBS) having the cubic shape in the same manner as in Prior Art 2.

Here, in the beam shaping/PBS synthesizing prism 14, the beams of an elliptic light intensity distribution whose horizontal direction is short by an emission structure of the laser light from the semiconductor laser 11 are refracted by the incidence surface 14a inclined in a horizontal direction (sheet surface direction) in accordance with a predetermined prism vertical angle with respect to a first emission surface 14c which is the opposite side of the incidence surface 14a via a polarized light separating surface 14b. Accordingly, a beam diameter of the horizontal direction is enlarged in accordance with a shaping magnification. In this case, since a width of the beam in a direction vertical to the sheet surface is unchanged in refraction through the incidence surface 14a inclined in the horizontal direction in accordance with the predetermined prism vertical angle, the beam of the elliptic light intensity distribution is shaped into that of a substantially circular light intensity distribution. Moreover, the beam of the shaped substantially circular light intensity distribution is transmitted through the polarized light separating surface 14b to which a semi-transmitting reflective film is attached and emitted from the first emission surface 14c of the beam shaping/PBS synthesizing prism 14, and is incident upon sphere aberration correction means 15. The sphere aberration is corrected with respect to three beams by the sphere aberration correction means 15.

The sphere aberration correction means 15 corrects the sphere aberration generated by an optical condenser system disposed on the optical axis between the semiconductor laser 11 and the signal surface 1b of the extra-high density optical disc 1. As enlarged and shown also in FIG. 8, the means comprises a concave lens (negative lens) 15A disposed on a semiconductor laser 11 side, an actuator 15B which displaces the concave lens 15A along an optical axis direction, and a convex lens (positive lens) 15C disposed on the side of an objective lens 18 described later. Moreover, the concave lens 15A is displaced with respect to the convex lens 15C in the optical axis direction by the actuator 15B, an interval between the concave lens 15A and the convex lens 15C is controlled, and parallelism of three beams incident upon the objective lens 18 is adjusted to generate a sphere aberration by a magnification error of the objective lens 18. The generated sphere aberration offsets other sphere aberrations to correct the total sphere aberration. It is to be noted that a combination of the concave lens 15A, actuator 15B, and convex lens 15C has been used as the sphere aberration correction means in the embodiment, but a wavefront modulation element using a liquid crystal element or the like may also be applied instead.

Thereafter, the three beams which have passed through the sphere aberration correction means 15 are turned by approximately 90° by a rising mirror 16, and subsequently transmitted through a phase plate 17 to form a circularly polarized light. In this case, the phase plate 17 gives a phase difference of approximately ¼ wavelength (90°) at the time of transmission of the three beams.

Further, thereafter the three beams which have passed through the phase plate 17 are incident upon the objective lens 18 designed for an extra-high density optical disc. The numerical aperture (NA) of the objective lens 18 is set to 0.75 or more in accordance with the extra-high density optical disc 1, and at least one of first and second surfaces 18a, 18b oppositely directed is formed in an aspheric surface. The objective lens 18 in the embodiment is a single lens having a numerical aperture (NA) of 0.85, and both the first and second surfaces 18a, 18b are formed in aspheric surfaces. In this case, the objective lens 18 is attached to an upper part in a lens holder 19, and a focus coil 20 and tracking coil 21 are integrally attached to an outer periphery of the lens holder 19. Moreover, the objective lens 18 is supported integrally with the lens holder 19 rockably in a focus direction and tracking direction of the extra-high density optical disc 1 via a plurality of suspension wires (not shown) fixed to an outer surface of the lens holder 19.

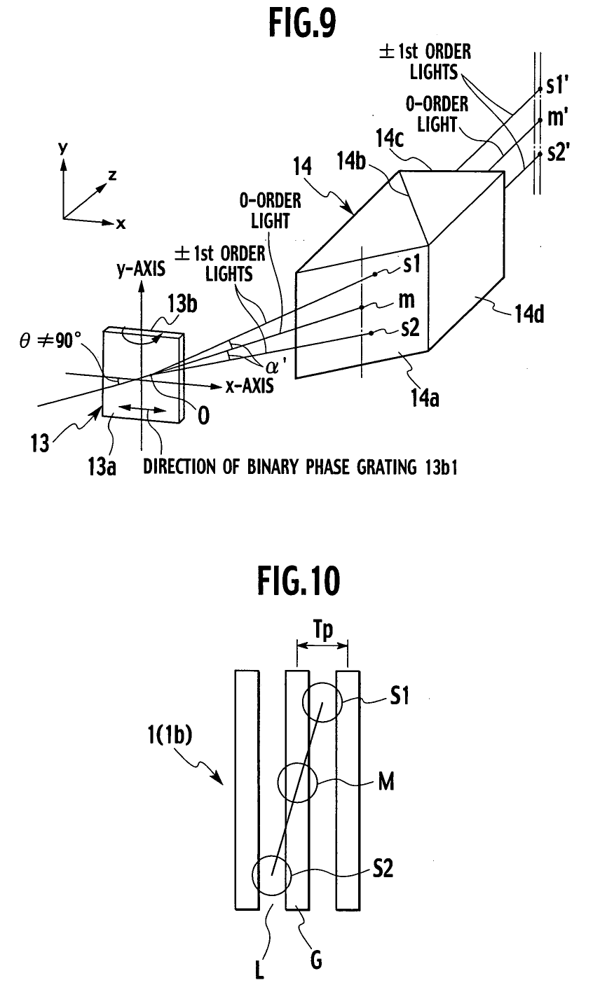

Moreover, the three beams incident upon the objective lens 18 are focused by the lens to obtain a main beam by a 0-order light and a pair of sub-beams by ±1st order lights, and the main beam and the pair of sub-beams are incident upon the laser beam incidence surface 1a of the extra-high density optical disc 1 and applied onto the signal surface 1b of the extra-high density optical disc 1. Then, a main spot M is converged on a groove G of the signal surface 1b of the extra-high density optical disc 1 shown in FIG. 10 as described later, and the pair of sub-spots S1, S2 are converged on lands L, L formed on the both sides of the groove G. In this case, the pair of sub-spots S1, S2 are disposed in a position apart from the main spot M by ½ of a track pitch Tp in a radial direction of the extra-high density optical disc 1.

Thereafter, in reverse to the above order, return light reflected by the signal surface 1b of the extra-high density optical disc 1 passes through the objective lens 18, phase plate 17, rising mirror 16, and sphere aberration correction means 15, and is reflected by the polarized light separating surface 14b of the beam shaping/PBS synthesizing prism 14 to turn its direction by approximately 90°. Thereafter, the light is emitted from a second emission surface 14d crossing the first emission surface 14c at right angles, and passes through a convex lens 22 and cylindrical lens 23 in that order to reach a photodetector 24. Moreover, the photodetector 24 detects a main signal, focus error signal, and tracking error signal from the signal surface 1b of the extra-high density optical disc 1.

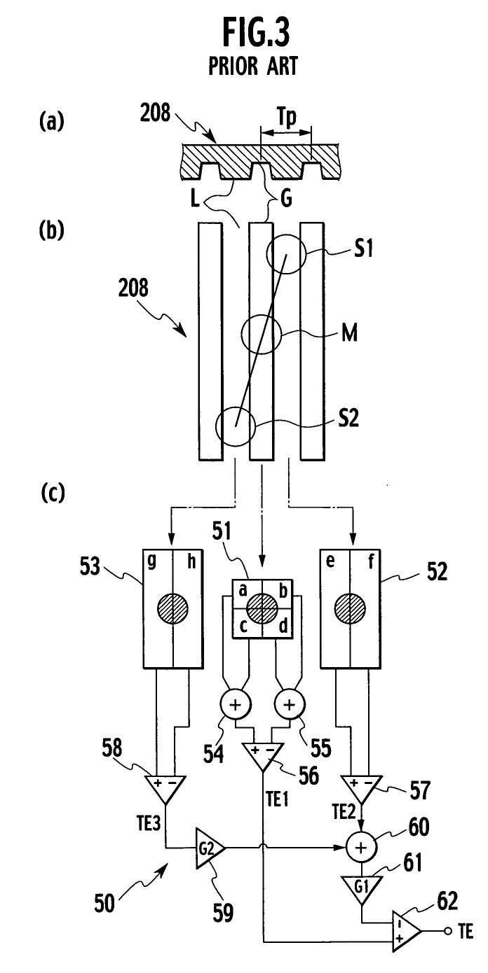

In this case, the tracking error signal is detected by a tracking error signal detection circuit 50 to which a DPP method described above with reference to (c) of FIG. 3 is applied.

Here, a structural configuration for solving the conventional problem with respect to the diffraction grating 13 for producing three beams and beam shaping/PBS synthesizing prism 14, which constitute a main part of the present invention, will be described with reference to FIGS. 9 and 10.

FIG. 9 is a perspective view schematically showing a structural configuration in which the conventional problem with respect to the diffraction grating for producing three beams and beam shaping/PBS synthesizing prism is solved in the optical pickup device according to the present invention. FIG. 10 is a plan view showing that the extra-high density optical disc is irradiated with three beams emitted from the beam shaping/PBS synthesizing prism shown in FIG. 9.

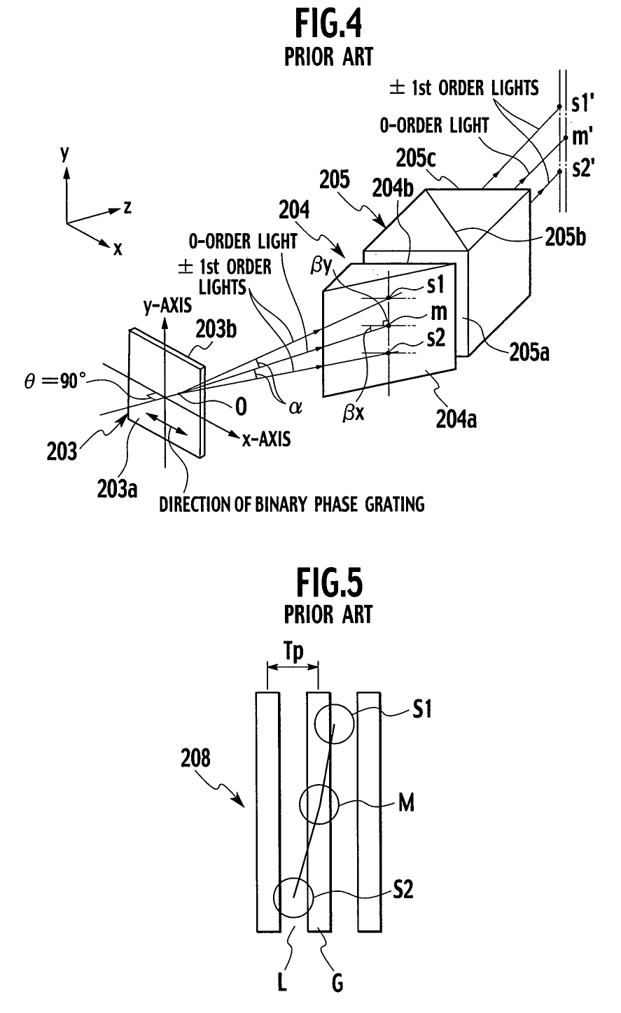

As described above in “BACKGROUND OF THE INVENTION” with reference to FIG. 4, it is known beforehand in Prior Art 2 that, when three beams of the 0-order light and ±1st order lights emitted from the diffraction grating 203 are incident upon the incidence surface 204a of the beam shaping prism 204 linearly along the vertical direction (y-axis direction), the ±1st order lights emitted from the emission surface 204b deviate with respect to the 0-order light, for example, toward the left side (−x side) in the x-direction due to refraction through the incidence surface 204a. In view of the above, according to the present invention, as shown in FIG. 9, the three beams of the 0-order light and ±1st order lights emitted from the diffraction grating 13 are not incident upon the incidence surface 14a of the beam shaping/PBS synthesizing prism 14 linearly along the vertical direction (y-axis direction). With respect to the 0-order light, the ±1st order lights are displaced beforehand in a reverse direction and incident upon the incidence surface 14a so as to cancel the deviation into the x-direction caused by the refraction through the beam shaping/PBS synthesizing prism 14.

That is, as shown in FIG. 9, when three beams obtained by the diffraction grating 13 are enlarged by the beam shaping/PBS synthesizing prism 14 to shape the elliptic light intensity distribution thereof into the substantially circular light intensity distribution, a horizontal direction for enlarging three beams by the beam shaping/PBS synthesizing prism 14 is set to an x-axis, and an axis crossing a plane including the x-axis and optical axis of laser light at right angles is set to a y-axis. Then, the diffraction grating 13 can be indicated by a rectangular xy-plane including the x-axis and y-axis, and as described above, the xy-plane has the incidence surface 13a on the side of the collimator lens 12 and the emission surface 13b on the opposite side of the incidence surface 13a. Moreover, as described above, a binary phase grating 13b1 includes concave/convexes having a predetermined pitch formed in parallel with the x-axis on the emission surface 13b included in the xy-plane.

Here, in the diffraction grating 13, the xy-plane is rotated centering on the y-axis, and the angle formed by the xy-plane and the optical axis of the laser light L is set to a predetermined angle θ other than a right angle. In this case, the predetermined angle θ is determined based on the diffraction angle of the ±1st order lights by the binary phase grating 13b1 formed on the emission surface 13b of the diffraction grating 13, and shaping magnification of the incidence surface 14a inclined in the horizontal direction in accordance with a predetermined prism vertical angle of the beam shaping/PBS synthesizing prism 14.

The laser light L emitted from the semiconductor laser 11 is incident upon the incidence surface 13a of the diffraction grating 13 in a state in which the diffraction grating 13 is rotated to the position of the predetermined angle θ centering on the y-axis. Then, the laser light L is diffracted in accordance with the diffraction angle of the ±1st order lights by the binary phase grating 13b1 formed on the emission surface 13b of the diffraction grating 13, and the three beams of the 0-order light and ±1st order lights are emitted from a point O of the emission surface 13b. The 0-order light among the three beams travels straight as it is without being diffracted by the binary phase grating 13b1 to reach the position of the point m on the incidence surface 14a of the beam shaping/PBS synthesizing prism 14 while keeping a state of 0° with respect to the optical axis of the laser light L both in the x-direction and y-direction. The 0-order light incident on the incident surface 14a is diffracted therethrough in accordance with the incident angle thereof.

On the other hand, the ±1st order lights among the three beams are diffracted by the binary phase grating 13b1, and are incident at angles different in both the x-direction and y-direction from those of the 0-order light. The ±1st order lights are diffracted vertically symmetrically by an angle α′ centering on the 0-order light to reach point s1, s2 on the incidence surface 14a of the beam shaping/PBS synthesizing prism 14. However, since the diffraction grating 13 is rotated beforehand by the predetermined angle θ centering on the y-axis, the points s1, s2 on the incidence surface 14a are positioned deviating from the point m toward the right side (+x side) in the x-direction. Moreover, when the points s1, m, and s2 on the incidence surface 14a are interconnected, the respective points are not linearly arranged, but form a “<” shape. On the other hand, as described in the conventional problem, the beam shaping/PBS synthesizing prism 14 has a characteristics that the ±1st order lights are emitted in a “>” shape with respect to the 0-order light. Therefore, the ±1st order lights are emitted in the “<” shape with respect to the 0-order light by the rotation of the diffraction grating 13 to cancel the directions of refraction and emission in the beam shaping/PBS synthesizing prism 14. Accordingly, when the 0-order light and the ±1st order lights are emitted from the emission surface 14c of the beam shaping/PBS synthesizing prism 14, they are linearly arranged on the same line.

That is, the beam shaping/PBS synthesizing prism 14 has a property that causes deviation toward the left side (−x side) in the x-direction as described above. Therefore, when the three beams incident upon the incidence surface 14a with the deviation toward the right side (+x side) in the x-direction are emitted from the emission surface 14c, the deviation in the x-direction is canceled. At the time of the emission from the first emission surface 14c, the 0-order light is positioned in a point m′, and the ±1st order lights are linearly positioned vertically along the y-axis direction with the point m′ between. In other words, as described above, when the ±1st order lights having an angle in the y-direction are incident upon the incidence surface 14a of the beam shaping/PBS synthesizing prism 14 inclined in the x-direction, the refraction of the x-direction deviates with respect to the 0-order light in accordance with the angle of the y-direction. To cancel this deviation, the lights are incident upon the incidence surface 14a of the beam shaping/PBS synthesizing prism 14 beforehand at the angle of the x-direction, which is different from that of the 0-order light.

In a concrete example, the laser light having a reference wavelength of 408 nm is emitted from the semiconductor laser 11, and the laser light is incident upon the incidence surface 13a of the diffraction grating 13 and diffracted by a binary phase grating 13b1 formed at a predetermined pitch of 43 μm in parallel with the x-axis on the emission surface 14c to produce the three beams of the 0-order light and ±1st order lights. In this case, when the diffraction grating 13 is rotated while changing the angle θ centering on the y-axis, shift amounts of the ±1st order lights in the x-direction, emitted from the emission surface 13b of the diffraction grating 13, are as shown in Table 3. In the present embodiment, θ=45° is used as the predetermined angle θ.

TABLE 3

| Rotation | | | | |
|---|---|---|---|---|
| angle θ of | +1st order light | | −1st order light | |
| diffraction | x- | y- | x- | y- |
| grating | direction | direction | direction | direction |
| 0 | 0 | −0.0543652 | | −0.0543652 |
| 5 | −0.000226 | −0.0543652 | −0.000226 | −0.0543652 |
| 10 | −0.000455 | −0.0543652 | −0.000455 | −0.0543652 |
| 20 | −0.000939 | −0.0543652 | −0.000939 | −0.0543652 |
| 30 | −0.001489 | −0.0543652 | −0.001489 | −0.0543652 |
| 40 | −0.002164 | −0.0543652 | −0.002164 | −0.0543652 |
| 45 | −0.002579 | −0.0543652 | −0.002579 | −0.0543652 |

unit: degree

Thereafter, as described above with reference to FIG. 6, the three beams emitted from the first emission surface 14c of the beam shaping/PBS synthesizing prism 14 pass through the sphere aberration correction means 15 for correcting the sphere aberration, pass through the rising mirror 16 for bending a light path and the phase plate 17 in that order, and are incident upon the objective lens 18.

Moreover, as shown in FIG. 10, the three beams emitted from the emission surface 14c of the beam shaping/PBS synthesizing prism 14 are applied onto the signal surface 1b of the extra-high density optical disc 1 via the objective lens 18 (FIG. 6), and the main spot M by the 0-order light and the sub-spots S1, S2 by the ±1st order lights are converged onto the signal surface 1b while grating-adjusting the diffraction grating 13. In the grating-adjustment, when the diffraction grating 13 is slightly rotated centering on the optical axis of the laser light, and adjusted so as to dispose, for example, one sub-spot S2 in a middle position (½ track position=Tp/2) of the land L on the left side of the groove G, then the main spot M is disposed in a middle position of the groove G. Furthermore, since the three beams emitted from the emission surface 14c of the beam shaping/PBS synthesizing prism 14 are linearly arranged as described above, different from the conventional art, the other sub-spot S1 is also disposed in the middle position (½ track position=Tp/2) of the land L on the right side of the groove G. At this time, the line connecting the sub-spot S1 and the main spot M and the sub-spot S2 is straight without forming the “>” shape as in the conventional art. The sub-spots S1, S2 can be disposed in the positions apart completely by ½ track in a state in which the main spot is disposed in the center of the groove G.

In this case, with respect to the main spot M of the 0-order light, the sub-spots S, S2 of the ±1st order lights are converged at an interval represented by the following equation in accordance with a focal distance f of the objective lens 18:
f×tan δ (δ: incident angles of the ±1st order lights upon the objective lens).

Therefore, after the three beams emitted from the emission surface 14c of the beam shaping/PBS synthesizing prism 14 are applied onto the signal surface 1b of the extra-high density optical disc 1 via the objective lens 18 (FIG. 6), the diffraction grating 13 is grating-adjusted. Then, the binary phase grating 13b1 formed on the emission surface 13b of the diffraction grating 13 is arranged substantially in parallel with the x-axis.

As described above, when the three beams emitted from the beam shaping/PBS synthesizing prism 14 are applied via the objective lens 18 onto the signal surface 1b of the extra-high density optical disc 1 formed by narrowing the track, the main spot M by the 0-order light is converged on the groove G (or the land L) on the signal surface 1b of the extra-high density optical disc 1. Moreover, the pair of sub-spots S1, S2 by the ±1st order lights are securely converged onto the lands L, L (or the grooves G, G) formed on the both sides of the groove G (or the land L). In other words, the pair of sub-spots S1, S2 can be disposed in the positions apart completely by ½ track in the state in which the main spot M is disposed in the center of the groove G (or the land L). Accordingly, the tracking error signal can be securely detected from the signal surface 1b of the extra-high density optical disc 1 by the DPP method. Moreover, the offset or the phase shift is not generated in the tracking error signal. Therefore, the information signals can be recorded or reproduced with extra-high density.

It should be understood that many modifications and adaptations of the invention will become apparent to those skilled in the art and it is intended to encompass such obvious modifications and changes in the scope of the claims appended hereto.

1. An optical pickup device comprising:
a semiconductor laser device which emits laser light having an elliptic light intensity distribution;
a collimator lens which converts the laser light into parallel beams;
a diffraction grating which diffracts the parallel beams to separate them into three beams of a 0-order light and ±1st order lights;
a beam shaping prism which enlarges diameters of the three beams to shape the elliptic light intensity distribution into a substantially circular light intensity distribution; and
an objective lens which irradiates an optical recording medium with the three beams shaped by the beam shaping prism,
wherein assuming that an optical axis direction of a ray incident upon the beam shaping prism is a z-axis and two axes crossing the Z-axis at right angles are an x-axis and a y-axis, a direction of gratings of the diffraction grating is set to have a predetermined angle with respect to the X-axis so that spots on the optical recording medium based on the three beams emitted from the beam shaping prism align.

2. The optical pickup device according to claim 1, wherein the objective lens has a numerical aperture of 0.75 or more.
